(19) United States
(12) Patent Application Publication
(10) Pub. No.: US 2025/0287471 A1
(43) Pub. Date: Sep. 11, 2025

(54) CIRCUIT ARRANGEMENT AND ELECTRIC HEATER FOR USE IN A VEHICLE

(71) Applicant: WEBASTO SE, Stockdorf (DE)

(72) Inventors: Rudolf Haeussermann, Stockdorf (DE); Alexander Henne, Stockdorf (DE)

(21) Appl. No.: 19/072,334

(22) Filed: Mar. 6, 2025

(30) Foreign Application Priority Data
Mar. 8, 2024 (DE) 10 2024 202 201.2

(51) Int. Cl. H05B 3/60; B60H 1/22

(52) U.S. Cl. CPC H05B 3/60; B60H 1/2221; H05B 2203/021; H05B 2203/022

(57) ABSTRACT

Circuit arrangement (1) for an electric heater, in particular an electric fluid heater (12), for use in a vehicle, comprises a connection for providing a voltage, in particular a high-voltage, wherein the connection has a first connection pole (HV+) for a first operating voltage potential and a second connection pole (HV−) for a second operating voltage potential, a heating resistor (R_{H}) which is configured to convert a current flowing through the heating resistor (R_{H}) into heat, when the voltage is applied, an electronic switch (S1) which is connected in series with the heating resistor (R_{H}) between the first connection pole (HV+) and the second connection pole (HV−), a control device (42) which is connected to the electronic switch (S1) and is configured to operate the switch (S1) in a pulsed manner in order to set a heating power of the electric fluid heater (12), and an input capacitor (C1) which is connected in parallel with the series-connected heating resistor (R_{H}) and switch (S1) between the first connection pole (HV+) and the second connection pole (HV−). The heating resistor (R_{H}) includes a first partial resistor (R1) and a second partial resistor (R2) that are connected in series and define a center tap (34, 36, 38) between them. The circuit arrangement (1) also has an additional capacitor (C2) which is connected between the center tap and the second connection pole (HV−).

This application claims priority to German Patent Application No. 10 2024 202 201.2 filed Mar. 8, 2024, the contents of which application are hereby incorporated by reference as if set forth in their entirety herein.

### TECHNICAL FIELD

The present disclosure relates to a circuit arrangement and an electric heater, in particular an electric fluid heater, having the circuit arrangement for use in a vehicle.

### TECHNICAL BACKGROUND

It is known that electric heaters for vehicles, in particular electric fluid heaters, can have one or more heating elements which each comprise a heating conductor layer arranged on a support element. The heating conductor layer includes a heating conductor track and connection regions for making electrical contact with the heating conductor track. The heat required for the heating operation can be generated in the heating conductor tracks of the heating conductor layer by applying a voltage, wherein the heating conductor layer acts as a heating resistor. A heating power can be set in each case, for example, by pulsed operation, in particular by pulse width modulation (PWM), pulse frequency modulation (PFM), constant-on-time-control (COT) or similar methods which are known per se.

Pulsed operation is associated with abrupt current and voltage jumps. Such current and voltage jumps can lead to line-related disturbances. In order to meet the generally existing requirements for EMC compatibility, those current and voltage jumps must be filtered out. Otherwise, there is the risk that electronic components of the circuit arrangement involved or of connected devices are damaged, that undesired electromagnetic radiation occurs in relevant frequency ranges, or that unpleasant noises is generated.

For this purpose, electronic filter components, for example an input capacitor, also referred to as a DC-link capacitor, or a common-mode choke, are generally provided in the circuit arrangements in question, said filter components in each case fulfilling certain functions and being correspondingly dimensioned.

High-voltage heaters, in particular high-voltage fluid heaters, for vehicles are operated, for example, with a voltage of greater than or equal to 250 volts, for example in a range from 250 V to 490 V in the case of a so-called 400 V heater, in particular also with a voltage of greater than or equal to 500 V, greater than or equal to 700 V, 800 V or 1.000 V, etc. Associated with this are very high heating powers of, for example, 5 KW, 8 KW, 10 KW or more. The correspondingly high-frequency-switched voltages and currents in this case require, for example in the case of the input capacitor, dimensions or variables which already occupy a significant volume of the control housing in the heating device in question, wherein there generally arises a need for saving space. Even more seriously, however, the considerable costs for the component are added here as a result of the increased capacity which the input capacitor has to provide under these conditions. Costs and size of the capacitor component are thus already significant both in the design and the production of electric high-voltage heating devices for use in vehicles.

### SUMMARY

The present disclosure is therefore based on the object of providing a circuit arrangement for an electric heater, in particular an electric fluid heater, and such an electric heater, in particular an electric fluid heater for a vehicle, which circuit arrangement, in comparison with known heaters, involves less costs and, furthermore, is also of space-saving design.

According to various aspects of the disclosure, a circuit arrangement for an electric heater, in particular an electric fluid heater, for use in a vehicle is provided. Said circuit arrangement comprises an electrical connection for supplying a voltage, in particular a high-voltage, wherein the electrical connection includes a first terminal pole for a first voltage potential and a second terminal pole for a second voltage potential (for example ground potential). The power supply can be provided at the electrical connection terminals, for example, by a vehicle battery. The voltage provided is a DC voltage.

Furthermore, the circuit arrangement comprises a heating resistor which is configured to convert a current flowing through the heating resistor, when the voltage is applied, into heat, and an electronic switch which is connected in series with the heating resistor between the first terminal pole and the second terminal pole. The electronic switch can be a power switch, in particular a power MOSFET or an IGBT, etc. Furthermore, the circuit arrangement comprises a control apparatus which is connected to the electronic switch and is configured to operate the switch in a pulsed manner, for example in a pulse-width-modulated (PWM) or pulse-frequency-modulated (PFM) manner, in order to set a heating power of the electric heater. Other pulsed operating methods such as, for example, COT (constant-on-time-control), etc., are also possible.

Furthermore, the circuit arrangement also has an input capacitor which is connected in parallel with the heating resistor, which is connected in series with the switch, and connected between the first terminal pole and the second terminal pole. This input capacitor serves as a filter capacitor for smoothing voltage jumps which are caused by the switch, in particular during the switching operation. The input capacitor is also referred to as a DC-link capacitor.

A special feature of the present aspects is that, while the heating resistor comprises a first partial resistor and a second partial resistor which are connected in series and define a center tap, also denoted as a center connection point, between them, the circuit arrangement furthermore has an additional capacitor which is connected between this center tap and the second terminal pole-that is to say in parallel with the second partial resistor but in series with the first partial resistor.

The circuit arrangement may accordingly provide that the input capacitor together with the first and the second partial resistor, or the entire heating resistor, form a first low-pass filter, and the additional capacitor only together with the first partial resistor of the heating resistor form a second low-pass filter, with the result that the overall circuit arrangement forms a second-order low-pass filter. Just as a result of this construction, the attenuation of the filter of, for example, 20 dB per decade (frequency) may be amplified to 40 dB in comparison with a conventional arrangement in which only the input capacitor is provided, but not an additional capacitor as described above.

However, what is decisive for the advantage to be achieved is less an amplified attenuation but rather the possibility of being able to design the input capacitor to be smaller in terms of its size (both the dimensions and the capacitance) and nevertheless at the same time to meet the requirements in respect of EMC (electromagnetic compatibility) by virtue of the additional capacitor being added to the circuit arrangement as described.

In this case, according to embodiments, the additional capacitor may have a (second) value of the capacitance which is lower than the corresponding (first) value of the capacitance of the input capacitor. It has been found that a value which is already lower by a multiple of powers of tens is sufficient for the additional capacitor in order to permit a reduction by, for example, half or more of the first capacitance value of the input capacitor with regard to the same filter effect (from a certain frequency range)—in comparison with the conventional case, while in each case meeting the same requirements for EMC.

In this case, according to embodiments, the sum of the two capacitance values is less than the one capacitance value according to the conventional case, in each case again with the requirement that the EMC-requirements are fulfilled. Thereby, the costs for the additional are low in view of the low requirements regarding capacity. This also holds true for its dimensions. Furthermore, the additional capacitor may also be attached to a printed circuit board in the usual way, e.g. using THT technology, so that any additional work involved in assembly remains manageable. By contrast, the large input capacitor can be designed to be considerably more favorable and, for example, only brings about half of the BOM (bill-of-material) costs. The same applies to its dimensions, with the result that considerable space can be saved in the housing. Overall, therefore, cost reduction and space saving can be achieved by the aspects according to the disclosure.

By way of example, the first capacitance value of the input capacitor can be larger by at least a factor of 10 than the second capacitance value of the additional capacitor, preferably by at least a factor of 100, further preferably by at least a factor of 1000.

Moreover, edges of voltage pulses are also reduced by the above aspects, in particular those occurring at a high-side portion of the heating conductor, and therefore also the generated common-mode interferences are reduced. As a result, the requirements for a common-mode choke that may be present as well can also be relaxed indirectly.

Furthermore, a second-order filter, as is achieved in the present case, may not be simply generated by a mere additional resistor, which might be considered being obvious at first glance, even when it would be realized that there is a need for action. This is because a considerable power loss would arise in that case, i.e. power that cannot be utilized. Instead, a portion of the heating resistor is utilized in conjunction with a further, additional capacitor, in order to improve the filter effect, or to relieve the input capacitor in the case of a same filter effect, in order to be able to design said input capacitor to be smaller.

According to a specific embodiment of aspects of the circuit arrangement, the first partial resistor and the second partial resistor have the same value of the ohmic resistance. The voltage divider in the heating resistor, which voltage divider is configured for the additional capacitor, is thus implemented here with a voltage arising at the center tap, or center connection point, with half the value of the maximum voltage, or the provided operating voltage, respectively. On the one hand, it has been shown that a good, if not optimal, decoupling of potentially resonant circuit components is achieved here, while on the other hand, an optimum potential for component size reduction with regard to the input capacitor arises hereby.

However, other ratios between values of the first partial resistor and of the second partial resistor are basically likewise possible, preferably in a ratio range of 1/4 to 4, further preferably in a ratio range of 2/3 to 3/2. If the location of the center tap, or center connection point, is shifted too far to the high-side end of the entire heating resistor, then the additional capacitor approaches a mere parallel connection to the input capacitor. Its function is then reduced to a mere additional contribution to the overall capacitance. If, by contrast, the location of the center tap, or center connection point, is shifted too far to the low-side end of the entire heating resistor, then the additional capacitor loses considerably its effect on account of the decreasing resistance, such that its contribution to the size reduction of the input capacitor disappears.

It should be noted that, in the case of the circuit arrangement according to the above aspects and embodiments, both the input capacitor and the additional capacitor in each case form electronic components, that is to say are embodied as discrete components, for example on a respective printed circuit board, or are configured as specifically structured capacitor elements on a respective substrate (in the case of structures formed on ceramic substrates by thick-film technology), and are specifically not provided as parasitic structures, for instance as outer housing parts interacting randomly with the conductor tracks of the arrangement, which cannot always be avoided.

Further aspects of the disclosure provide an electric fluid heater for a vehicle, which electric fluid heater has a circuit arrangement as described above.

In the present case, an electric fluid heater is understood to mean such a heater in which heat is emitted to a liquid heat transfer medium of a heat transfer circulation system flowing through the heater. The heat transfer medium can be, in particular, liquid coolant of a vehicle, which liquid coolant transports heat in the vehicle and can emit it at different locations. Alternatively, the fluid heater can also be, for example, a constituent part of a heat pump of a vehicle, such that the heat transfer medium can be, for example, a refrigerant of a heat pump. In this case, it may be that the refrigerant is present only under certain conditions and only temporarily or perhaps also never in completely liquid form and is otherwise also partially or completely gaseous. Nevertheless, this is also understood to mean a fluid heater.

The electric fluid heater is provided for a vehicle. A vehicle is to be understood to mean, in principle, all possible mobile applications, in particular passenger cars, trucks or utility vehicles, construction machines, aircraft and watercraft. This also comprises, for example, construction machines or cranes and trailers such as caravans, which can be towed and transported by other vehicles.

The electric fluid heater preferably has a heating power of at least 3 KW, preferably at least 5 KW, further preferably of at least 7 KW, for example of at least 9 kW. The heating power is in each case preferably less than or equal to 13 kW. The operating voltage with which the vehicle heater is operated, that is to say the voltage, or high-volt- age, which is present between the connection poles of the connection of the circuit arrangement and which can be equal to the on-board voltage of an electrically driven vehicle, is greater than or equal to 250 V. By way of example, a heater referred to as 400 V heater can typically cover a voltage range of 250 V to 490 V. Higher voltage ranges are likewise comprised by the instant aspects, for example greater than or equal to 500 V, for example above 800 V, 900 V or 1000 V. The resulting value of the ohmic resistance of the heating resistor lies, for example, approximately in a range of 10 to 200 ohms.

The fluid heater has at least one heating element and at least one heating conductor layer. The heating conductor layer is arranged on a support element, which can be a ceramic substrate, in particular composed of Al₂O₃. The heating conductor layer has, in a heating conductor layer plane, which may also be curved, a heating conductor track which is defined in the heating conductor layer plane by at least one insulation interruption, wherein the heating conductor track forms the heating resistor of the circuit arrangement. In this case, the heating conductor layers and heating conductor tracks can be arranged jointly on a single support element, or else on two or three different support elements. Preferably, each heating conductor layer or each heating conductor track is applied on its own, separate support element. The heating conductor layer or the heating conductor tracks can be produced in a screen printing method and in thick-film technology on the ceramic substrate that conducts heat.

Furthermore, the fluid heater has the heat exchanger which is in thermal connection with the heating element. The heat converted by the heating resistor is transferred via the ceramic substrate and, if appropriate, an adhesion promoter to a fluid flowing through the heat exchanger.

Such a construction permits a particularly advantageous application of the circuit arrangement, since the heating resistor, which is configured as a heating conductor track, is relatively easily accessible on the substrate in order to configure, by means of a tap or connection point, for example by means of a bond conductor, at any desired location a voltage divider at which the additional capacitor can be implemented as described. An intervention in the structure of the heating element as such is not necessary for this purpose, rather the two partial resistors then extend directly on both sides from the tap or connection point.

According to a corresponding embodiment, the heating conductor track extends between a first terminal region and a second terminal region, in which the heating conductor track is electrically connected in each case to at least one electrical connection line which provides an electrical connection to the switch, or to one of the two connection poles, respectively. The center tap or connection point is located hereby in a section of the heating conductor track between the first terminal region and the second terminal region.

The center tap, or center connection point, itself may define a third terminal region which is connected to an electrical line, for example the above-mentioned bonding conductor, which provides an electrical connection to the additional capacitor. In a specific embodiment, a third terminal location, which is already provided in any case on the heating element, is used for this purpose, which is characterized by a surface which is locally broadened in the conductor track or is protruding laterally outwards. This broadened surface location may generally serve to provide an alternative wiring for the same heating element, in which the two strands of the conductor track are operated in parallel on both sides of the terminal location instead of in series with a corresponding voltage. A higher power is thereby possible. If this higher power is not required, this center tap, or center connection point, may, according to the embodiment, instead be utilized for the voltage divider, which is proposed according to the disclosure, with an additional capacitor connected thereto. An embodiment is described further below.

### BRIEF DESCRIPTION OF THE DRAWINGS

The disclosure is explained by way specific embodiments below with reference to the following drawings.

In the drawings:

FIG. 1 shows a schematic circuit diagram of a circuit arrangement for an electric fluid heater according to a comparative example;

FIG. 2 shows a top view of a heating element that can be used with the comparative example of FIG. 1 or the embodiment shown in FIG. 4;

FIG. 3 shows a schematic circuit diagram of a circuit arrangement for an electric fluid heater according to an alternative comparative example, but using the same heating element as in FIG. 1;

FIG. 4 shows a schematic circuit diagram of a circuit arrangement for an electric fluid heater according to the embodiment;

FIG. 5 shows an equivalent circuit diagram for the schematic circuit diagram from FIG. 4;

FIG. 6 shows a detail of the heating element shown in FIG. 5; and

FIG. 7 shows a simplified illustration of an electric fluid vehicle heater.

### DETAILED DESCRIPTION OF PREFERRED EMBODIMENTS

In the following description of the drawings, the same reference numerals designate the same or comparable components.

FIG. 1 shows a schematic circuit diagram of a circuit arrangement 1 for an electric fluid heater according to a comparative example.

The circuit arrangement 1 has a connection for a high-voltage, for example 400 V or 800 V, etc., which comprises a first connection pole HV+ for the actual operating voltage potential and a second connection pole HV− for the reference or ground potential. An ohmic resistor designated as an input resistor Re, which reflects, for example, line resistances or also the internal resistance of the vehicle battery, is likewise shown symbolically on the side of the first connection pole HV+. Corresponding impedances may also be included. A push-pull choke optionally present in the circuit arrangement is omitted for the sake of simplicity. This also applies to the remaining figures of the application.

An input capacitor C1 is connected between the two connection poles. This is also designated as a DC-link capacitor and has a filter function which, on the one hand, smoothes fluctuations of the voltage provided on the vehicle electrical system side and filters out voltage and current jumps due to a switching process by a switch S1 to be described below.

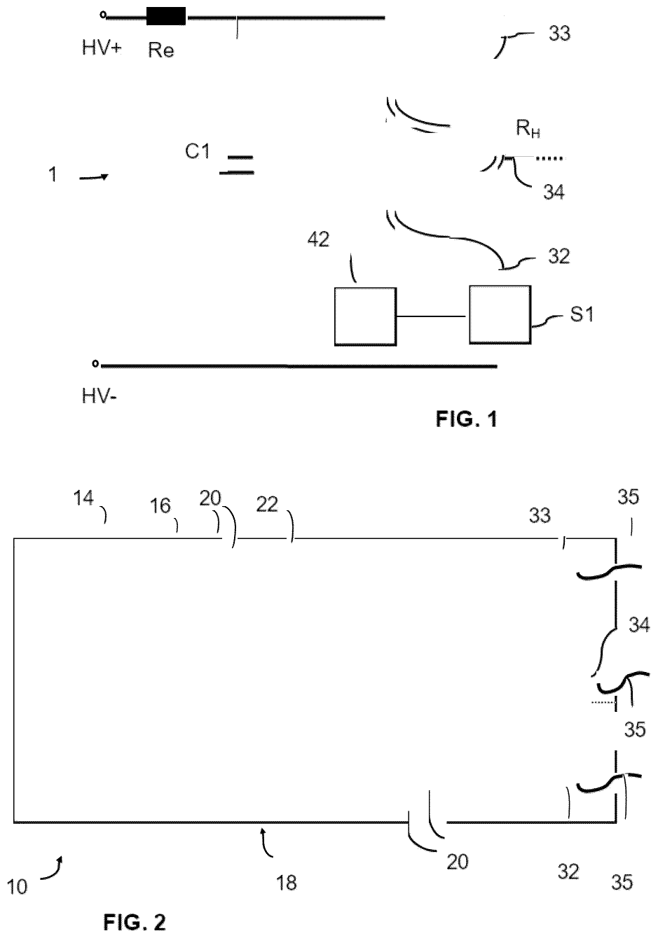

The circuit arrangement 1 also has—connected in parallel to the input capacitor C1—a heating resistor R_{H} which is formed by a heating conductor track 20 shown in FIG. 2, which will be discussed below. The heating resistor R_{H} is connected in series with the switch S1 which is operated in a pulse-width-modulated manner by a control device 42 in order to set a desired heating power. The switch S1 may be an IGBT or a power MOSFET, or the like. The control device 42 may be connected to an input device (not shown) via which, for example, a target temperature can be set, wherein either the input device or the control device 42 or a further device sets the duty factor for the pulse-width modulation in a known manner depending on the temperature with regard to which the switch S1 is operated.

FIG. 2 shows a top view of a heating element 10 that can be used with the comparative example of FIG. 1 (or the embodiment of FIG. 4 described further below). The heating element 10 includes a support element 14 formed as a ceramic substrate and a heating conductor layer 16 formed thereon. In the illustration, the support element 14 is almost completely covered by the heating conductor layer 16. The heating conductor layer 16 has been structured, for example, in a screen printing method, so that it forms the heating conductor track 20 indicated in FIG. 1 by means of a suitable arrangement of insulating interruptions 22. The heating conductor layer 16 may be formed on the support element 14 in a heating conductor layer plane 18.

The support element 14 has a rectangular shape. The heating conductor track 20 is defined by two end points which form a first terminal region 32 and a second terminal region 33. The heating conductor track 20 may be formed from a copper alloy and have a thickness of, for example, 12 μm without limiting the generality. The two terminal regions 32, 33 may be formed from the same material or be supplemented by an additional material in order to enable the connection, for example, of a bonding wire or another type of electrical connection line 35. In a third terminal region 34 arranged symmetrically in the center of the heating conductor tracks 20, a contact by an electrical connection line 35 may likewise be provided, as is also indicated schematically in FIG. 1 in the center of the heating resistor R_{H}. By means of the electrical connection lines 35, which may be bonding wires or bonding conductors, electrical energy can be supplied to the heating conductor track 20, which energy is converted into heat in the heating conductor track 20 and is emitted to the support element 14.

The electrical connection lines 35 may connect the terminal regions 32, 33 (and, if appropriate, 34) to connection electronics which are not illustrated in the figures. This may be a power board, a control unit which comprises power electronics, or the like. The switch S1 may be provided in a region of these connection electronics. Each terminal region 32, 33 (and, if appropriate, 34) may be electrically connected to more than one electrical connection line 35, wherein the number between the two connection lines may differ. The connection lines 35 extend from the terminal regions 32, 33 (and, if appropriate, 34) in the direction of a connection side which is on the right in FIG. 2, and beyond the edge of the heating conductor layer 16 extending on the connection side. As described, these may each be bonding wires.

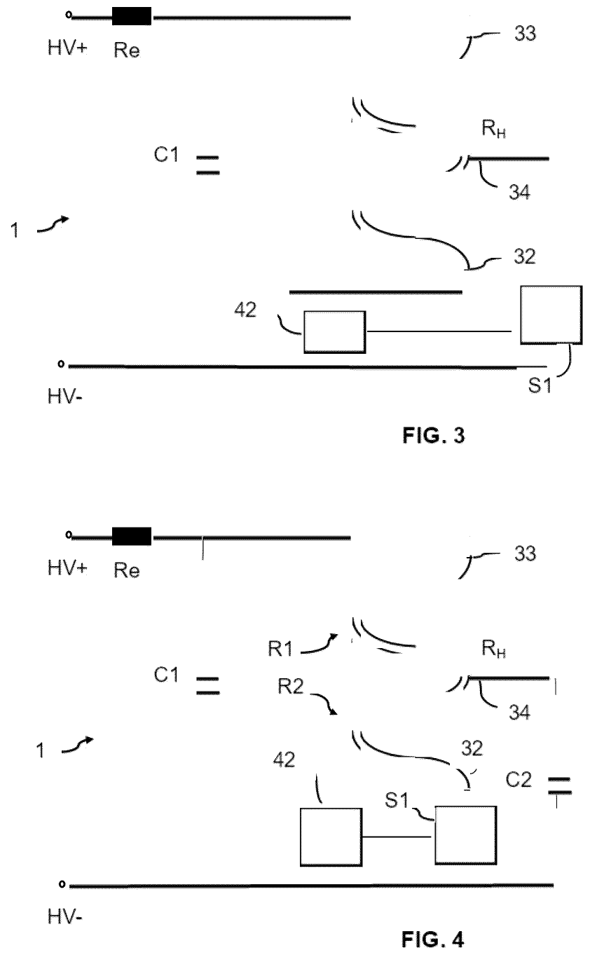

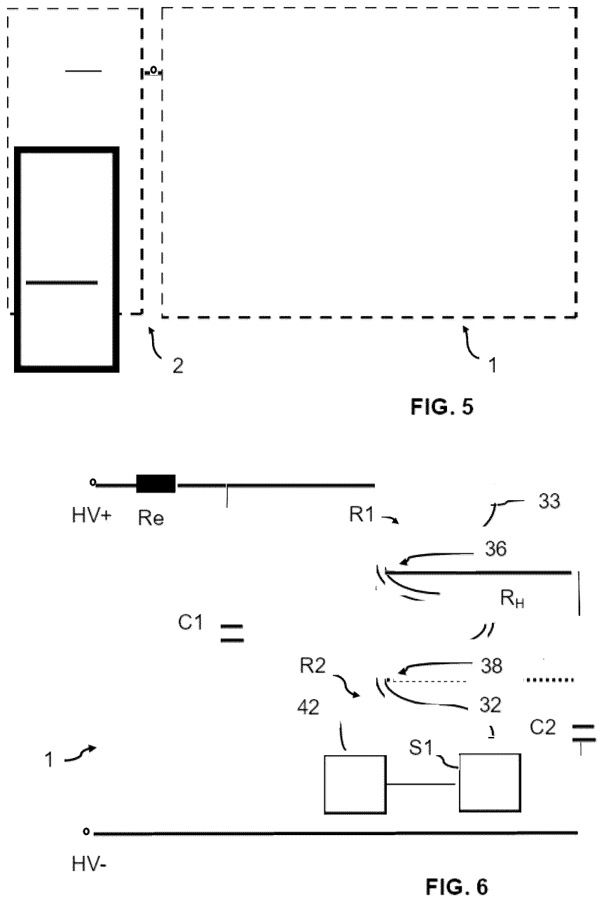

FIG. 3 shows an alternative circuit arrangement 1 according to a modified comparative example, which uses the same heating element 12 as shown in FIG. 2. In this modification, the two terminal regions 32 and 33 are connected to the first connection pole HV+ carrying the operating voltage potential, while the third terminal region 34 located in the center of the heating conductor track 20 is connected to the switch S1 and the latter is connected to the second connection pole HV−. Otherwise, the circuit arrangement 1 shown in FIG. 3 is identical to that shown in FIG. 1. The third terminal region 34 is used as a center tap (center connection point) and enables the heating resistor R_{H} to be divided into two portions, the resulting partial resistors thus being operated in parallel. The circuit arrangement 1 according to FIG. 3 therefore enables a greater heating power if the voltage provided is the same as in FIG. 1. The heating element 12 illustrated in FIG. 2 consequently permits flexible use, for example, in fluid heaters with differently predefined maximum powers, for example 400 W or 800 W devices.

FIG. 4 shows a circuit arrangement 1 according to a first embodiment of the present disclosure. As far as the elements contained therein are identical to those in FIG. 1 or FIG. 3, repetition is avoided herein and reference is made to the relevant description further above. In particular, the circuit arrangement 1 of FIG. 4 makes use of an input capacitor C1, a heating resistor R_{H}, a switch S1 and a control device 42 as described above. In the present specific embodiment, which does not limit the generality of the aspects, the center tap or the terminal region 34 provided for the variant with higher power according to FIG. 3 is used, for example, to set up a voltage divider. Because the center tap, or the terminal region 34, respectively, is provided centrally in the conductor track 20, the same conductor track lengths are located between the center tap and the first connection pole and the second connection pole, respectively, so that the resulting partial resistors R1, R2, which are present between the center tap and the first connection pole and between the center tap and the second connection pole, are also substantially identical. Half the operating voltage therefore arises between the center tap, or the third terminal region 34, respectively, and the second connection pole HV−.

In particular, however, an additional capacitor C2 is connected between the center tap, or the third terminal region 34, respectively, and the second connection pole HV−. In this case, the strand containing the additional capacitor C2 is connected in parallel with the second partial resistor R2, which is connected in series with the switch S1.

The capacitance values of the input capacitor C1 and of the additional capacitor C2, which together form a low-pass filter of the second order, are matched to one another in order to achieve a predetermined cutoff frequency and a predetermined damping behavior. If the capacitance of the capacitor C1 is significantly greater than that of the additional capacitor C2, 1/(2·π·R·C1) results for the cutoff frequency of the first low-pass filter, and 2/(π·R·C2) results for the cutoff frequency of the second low-pass filter, if R designates the total resistance. If the center tap is not located in the center of the heating conductor, then the second frequency is scaled accordingly. The cutoff frequencies can thus be adapted to the desired damping behavior. The predetermined cutoff frequency and the predetermined damping behavior comply with the same requirements as in the comparative examples shown in FIGS. 1 and 3.

The determination of the exact values of the capacitance required in the embodiment for the two capacitors C1, C2 is a complex task. However, the result is that the capacitance value of the input capacitor C1 can be at least approximately halved compared to the capacitance value of the input capacitor C1 according to the comparative example shown in FIG. 1 or 3, which saves costs and component size. At the same time, the additional capacitor C2 only needs to contribute a capacitance value powers of tens less than the capacitance value of the input capacitor C1 in order to achieve a filter effect that is desired overall in the mutual interaction.

FIG. 6 shows a modification according to a second embodiment. In contrast to the first embodiment according to FIG. 4, the center tap is not provided at the third terminal region 34 which is provided in the heating element 12, but rather at a first freely placed terminal region 36 along the heating conductor track 20, which is positioned in the direction of the second terminal region 33, i.e. in opposite direction to the technical current direction, as seen from the third terminal region 34. Accordingly, the first partial resistance R1 is now smaller than the second partial resistance R2. The center tap may hereby also be established by predetermined placement of a bonding conductor along the heating conductor track 20.

As is likewise shown in FIG. 6, namely by the dashed line towards the second placed terminal region 38 along the heating conductor track 20 and the associated double arrow, it is possible to set up an optimum ratio of R1 to R2 within the framework of the design during the production of the circuit arrangement 1, which achieves an optimum filter effect in the mutual interaction with the capacitance values of C1 and C2.

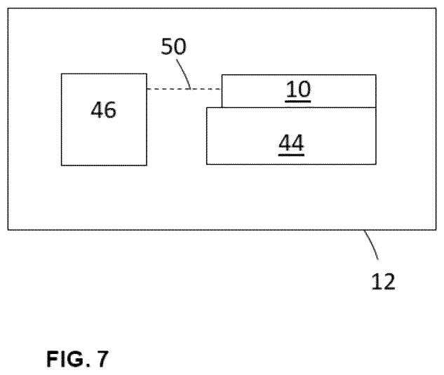

FIG. 7 shows a simplified illustration of an electric fluid heater 12 for a vehicle. The electric fluid heater 12 comprises, in addition to the electric heating element 10, a fluid heat exchanger 44, on which the electric heating element 10 according to the embodiments is arranged and to which the heat generated during the heating operation is transferred by the heating element 10, and a control unit 46 for controlling the electric heating element 10. The control unit 46 may comprise one or more printed circuit boards, on which the input capacitor C1, the additional capacitor C2, and the control device 42 are arranged. For this purpose, the control unit 46 is connected to the electric heating element 10 via electrical connection lines 50. According to specific embodiments, which do not limit the generality of the aspects, the heating element 10 may be assigned to a further printed circuit board, which has one or more power switching elements forming the switch S1. The connection lines 50 connect this printed circuit board to that of the control unit. The connection lines 50 may be formed as punched grids. The printed circuit board, which is not shown separately in FIG. 7 and has the power switching elements, may be connected to the heating element via the connection lines 35. Further components of the electric vehicle heater 12, which are not illustrated in FIG. 7 and which are not explicitly illustrated in FIG. 7 for the sake of simplicity, are well known to the person skilled in the art and are supplemented by the electric vehicle heater 12 in order to ensure the functional capability of the latter.

The features of the disclosure disclosed in the above description, in the drawings and in the claims may be essential for the realization of the disclosure both individually or in any combination.

### LIST OF REFERENCE SIGNS

1 Circuit arrangement
2 LISN (line impedance stability network)
10 Heating element
12 electric fluid heater
14 Support element
16 Heating conductor layer
18 Heating conductor layer plane
20 Heating conductor track
22 Insulating interruption
32 First terminal region
33 Second terminal region
34 Third terminal region
35 Electrical connection line
36 First freely placed terminal region
38 Second freely placed terminal region
39 Center tap
42 Control device
44 Heat exchanger
46 Control unit (control board)
50 Electrical connection line
S1 Electronic switch
R_{H} heating resistor
R1 first partial resistor
R2 second partial resistor
Re input resistor (mains power, internal resistance of the battery, or the like)
C1 input capacitor, DC-link capacitor
C2 additional capacitor

1. A circuit arrangement for an electric fluid heater, for use in a vehicle, comprising:
an electrical connection for providing a voltage, in particular a high-voltage, wherein the electrical connection has a first connection pole (HV+) for a first voltage potential and a second connection pole (HV−) for a second voltage potential;
a heating resistor (R_{H}) which is configured to convert a current flowing through the heating resistor (R_{H}) into heat, when the voltage is applied;
an electronic switch (S1) which is connected in series with the heating resistor (R_{H}) between the first connection pole (HV+) and the second connection pole (HV−);
a control device which is connected to the electronic switch (S1) and is configured to operate the switch (S1) in a pulsed manner in order to set a heating power of the electric fluid heater;
an input capacitor (C1) which is connected in parallel with the series-connected heating resistor (R_{H}) and switch (S1) between the first connection pole (HV+) and the second connection pole (HV−),
wherein
the heating resistor (R_{H}) comprises a first partial resistor (R1) and a second partial resistor (R2) which are connected in series and define a center tap between them; and
the circuit arrangement also has an additional capacitor (C2) which is connected between the center tap and the second connection pole (HV−).

2. The circuit arrangement (1) according to claim 1, wherein the input capacitor (C1) forms a first low-pass filter together with the first partial resistor (R1) and the second partial resistor (R2), and the additional capacitor (C2) forms a second low-pass filter together with the first partial resistor (R1), with the result that the circuit arrangement overall forms a low-pass filter of the second order.

3. The circuit arrangement according to claim 1, wherein the input capacitor (C1) has a first capacitance value and the additional capacitor (C2) has a second capacitance value, wherein the first capacitance value is greater than the second capacitance value.

4. The circuit arrangement according to claim 3, wherein the first capacitance value is greater than the second capacitance value by at least a factor of 10.

5. The circuit arrangement according to claim 1, wherein
the first partial resistor (R1) and the second partial resistor (R2) have the same value for the ohmic resistor.

6. The circuit arrangement according to claim 1, wherein the input capacitor (C1) and the additional capacitor (C2) each form electronic components which are fastened to one or more printed circuit boards.

7. An electric fluid heater, comprising:
a circuit arrangement according to claim 1;
a heating element having a support element and a heating conductor layer which is arranged on the support element, the heating conductor layer having, in a heating conductor layer plane, a heating conductor track which is defined in the heating conductor layer plane by at least one insulating interruption, the heating conductor track forming the heating resistor (R_{H}); and
a heat exchanger which is thermally connected to the heating element.

8. The electric fluid heater according to claim 7, wherein the heating conductor track extends between a first terminal region and a second terminal region in which the heating conductor track is electrically connected to each at least one electrical connection line, respectively, which establishes an electrical connection to the switch (S1), or to one of the two connection poles (HV+), respectively;
wherein the center tap is located in a section of the heating conductor track between the first terminal region and the second terminal region.

9. The electric fluid according to claim 8, wherein the center tap defines a third terminal region which is connected to an electrical conductor which establishes an electrical connection to the additional capacitor (C2).

10. The electric fluid according to claim 7, wherein the support element is a ceramic substrate and the heating conductor track is a conductor track formed from copper and formed on the support element using thick-film technology.

11. The circuit arrangement according to claim 3, wherein the first capacitance value is greater than the second capacitance value by at least a factor of 100.

12. The circuit arrangement according to claim 3, wherein the first capacitance value is greater than the second capacitance value by at least a factor of 1000.
